(19) United States
(12) Patent Application Publication
(10) Pub. No.: US 2026/0048707 A1
(43) Pub. Date: Feb. 19, 2026

(54) CONTROL DEVICE FOR A LOAD IN A VEHICLE CONTROL SYSTEM AND VEHICLE

(71) Applicant: HANON SYSTEMS EFP DEUTSCHLAND GMBH, Bad Homburg v.d. Höhe (DE)

(72) Inventor: Holger Schmidt, Bad Homburg v.d. Höhe (DE)

(21) Appl. No.: 19/288,013

(22) Filed: Aug. 1, 2025

(30) Foreign Application Priority Data
Aug. 14, 2024 (DE) 102024123189.0

(51) Int. Cl. B60R 16/023; H02J 1/08

(52) U.S. Cl. CPC B60R 16/023; H02J 1/082; H02J 2310/40

(57) ABSTRACT

A control device for a load in a vehicle with a first on-board network operated using a first voltage and a second on-board network operated using a second voltage, wherein the first voltage is greater than the second voltage, the control device comprising a reference voltage generating unit configured to provide a reference voltage; a signal voltage limiting unit configured to receive a bus signal from the second on-board network und to limit a voltage of the bus signal to at most the reference voltage; a bus signal receiving unit configured to receive the voltage-limited bus signal from the signal voltage limiting unit; and a supply voltage generating unit configured to generate, according to the voltage-limited bus signal, a supply voltage for the load based on the first voltage.

### CROSS REFERENCE TO RELATED PATENT APPLICATION

The present application claims priority to German Patent Application No. 102024123189.0 filed Aug. 14, 2024, the entire contents of which are incorporated herein for all purposes by this reference.

### TECHNICAL FIELD

Exemplary embodiments of the present invention relate to a control device for a load in a vehicle, in particular in a vehicle with two on-board networks which are operated with different voltages. Further exemplary embodiments relate to a corresponding control system and a corresponding vehicle.

### BACKGROUND

An on-board network refers to the entirety or a subset of all electrical components in a vehicle. The on-board network can be responsible for the power supply and data transmission between components and control units. Data is transmitted in digital or analog form as voltage signals. The Local Interconnect Network (LIN) bus, for example, is a widely used industry standard for digital data transmission in vehicles.

While in the past, vehicles were primarily operated with a single on-board network, a plurality of on-board networks is now increasingly being used, particularly in electrically powered vehicles. Several on-board networks can be connected to each other via a communication interface in order to ensure data transmission between the several on-board networks.

The on-board networks can be operated with different voltages, whereby data transmission via the communication interface is usually carried out with a comparatively low voltage. The on-board networks can share a common ground. By operating the on-board networks with different voltages, there is a risk that (e.g. as a result of a short circuit) an overvoltage of an on-board network operated with a comparatively high voltage is applied to the communication interface. Such an overvoltage can damage electrical components such as signal receivers or signal generators, which are configured for data transmission via the communication interface with the comparatively low voltage. This makes it necessary to protect the electrical components from an overvoltage caused by the on-board network, which is operated at the comparatively high voltage, and is conducted between the two on-board networks via the communication interface.

Overvoltage protection can be achieved by means of an insulating communication interface. On the one hand, a so-called optocoupler is known, which is a device for the galvanic isolation of two on-board networks. A DC or AC voltage signal from the first on-board network is converted into a light signal, which is then detected and converted into a DC or AC voltage signal for the second on-board network. A well-known example of this is the MLX81346 control device, as described in reference [1]. On the other hand, transformers or capacitors for inductive or capacitive isolation are known, but these can only transmit AC voltage signals via the respective isolation barrier, which is why they are usually less suitable for data transmission.

It is also known to replace electrical components with higher-quality components that are specially designed to withstand an overvoltage. A known example of this is the fault-tolerant LIN transceiver TLIN2029A-Q1, as described in reference [2]. It is also known to integrate dedicated level shifters in the communication interface, such as the I2C level shifter according to reference [3]. However, these approaches usually lead to higher material costs and additional development costs.

### REFERENCES

[1]: Melexis N.V., Datasheet MLX81346, Smart LIN pre-driver for DC and BLDC motors <2000W; April 2022; https://www.melexis.com/en/product/mlx81346
[2]: Texas Instruments Inc.; Datasheet TLIN2029A-Q1, Fault Protected LIN Transceiver with Dominant State Timeout; March 2021;
   https://www.ti.com/product/de-de/TLIN2029A-Q1
[3]: NXP Semiconductors; Datasheet AN10441, Level shifting techniques in I2C-bus design; June 2007; https://reserves.ub.rwth-aachen.de/record/125213
[4]: NXP Semiconductors, Datasheet TJA1021, ISO 17987/LIN 2.x/SAE J2602 transceiver; https://www.nxp.com/docs/en/data-sheet/TJA1021.pdf
[5]: NXP Semiconductors, S912ZVML31F1WKF; https://www.nxp.com/part/S912ZVML31F1WKF

### SUMMARY

The purpose of the present invention is to provide a compact and cost-effective overvoltage protection device that allows two on-board networks operating at different voltages to communicate with each other in a largely hazard-free manner.

An exemplary embodiment comprises a control device for a load in a vehicle with a first on-board network operated at a first voltage and a second on-board network operated at a second voltage, wherein the first voltage is greater than the second voltage. The control device comprises a reference voltage generating unit configured to provide a reference voltage. The control device further comprises a signal voltage limiting unit configured to receive a bus signal from the second on-board network and to limit a voltage of the bus signal to at most the reference voltage. The control device further comprises a bus signal receiving unit configured to receive the voltage-limited bus signal from the signal voltage limiting unit. The control device comprises a supply voltage generating unit configured to generate, according to the voltage-limited bus signal, a supply voltage for the load based on the first voltage.

A further exemplary embodiment comprises a control system for a load. The control system comprises the control device according to one embodiment and a bus signal generating device configured to generate bus signals and to transmit the bus signals to the control device.

A further exemplary embodiment comprises a vehicle comprising a control system according to one embodiment.

Further preferred embodiments are explained in more detail in the appended dependent claims and in the following detailed description of the invention.

### DESCRIPTION OF THE DRAWINGS

FIG. 1 shows a schematic representation of an exemplary system containing two on-board networks in a vehicle;

FIG. 2 shows a schematic representation of a control device according to an exemplary embodiment of the invention;

FIG. 3 shows a circuit diagram of a signal voltage limiting unit according to an exemplary embodiment of the invention;

FIG. 4 shows plots of the signal voltage at an input and an output of the signal voltage limiting unit according to an exemplary embodiment of the invention; and

FIG. 5 shows a circuit diagram of an integration of a signal voltage limiting unit according to an exemplary embodiment of the invention into a LIN-based control system.

### DESCRIPTION OF AN EMBODIMENT

Exemplary embodiments of the invention are described below with reference to the accompanying drawings. The same or equivalent components, elements and processes shown in the corresponding drawings are provided with the same reference signs, and redundant explanation thereof is omitted. Furthermore, the embodiments are merely examples and do not limit the invention. The features described in the following exemplary embodiments and combinations thereof are not necessarily essential to the invention.

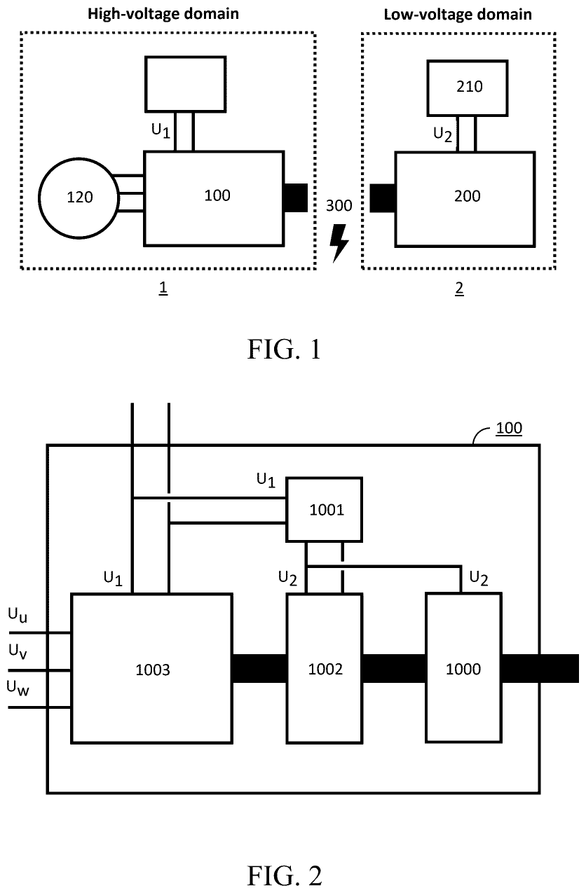

FIG. 1 shows a schematic representation of an exemplary system comprising two on-board networks in a vehicle. A first on-board network 1 is operated with a first voltage U₁ and a second on-board network 2 is operated with a second voltage U₂. The first voltage Uⱼ is greater than the second voltage U₂. For example, the first voltage Uⱼ is 48 V and the second voltage U₂ is 12 V. The first on-board network 1 can comprise a first operating voltage source 110, which provides the first voltage U₁. The second on-board network 2 may comprise a second operating voltage source 210, which provides the second voltage U₂. The first operating voltage source 110 and the second operating voltage source 210 can each be provided, for example, by a battery.

The first on-board network 1 and the second on-board network 2 can be communicatively coupled via a communication interface 300. Data can be transmitted via the communication interface 300. Preferably, the communication interface 300 comprises a bus, e.g. a Local Interconnect Network (LIN) bus, via which bus signals can be sent or received.

The first on-board network 1 can comprise a control device 100, with which a load 120 can be controlled. The load 120 is, for example, an electric motor. The second on-board network 2 can comprise a bus signal generating device 200, which is configured to generate bus signals and to transmit the bus signals to the control device 100. The control device 100 can comprise a bus signal receiving unit, which is configured to receive the bus signal. The bus signals can be digital voltage signals, where a logical one is a voltage signal with the value U₂ (e.g. 12 V) and a logical zero is a voltage signal with a value of 0 V.

The control device 100 may further comprise a supply voltage generating unit configured to generate, according to the bus signal, a supply voltage for the load 120 based on the first voltage U₁. The supply voltage generating unit may comprise an inverter configured to convert the first voltage Uⱼ into an AC voltage, for example a three-phase AC voltage U_{U}, U_{V}, U_{W}, which is applied to the load 120. For example, the supply voltage generating unit can control the operation of an inverter by means of pulse width modulation (PWM), whereby a PWM control signal is generated in accordance with the bus signal and the inverter generates, for example, a three-phase alternating voltage U_{U}, U_{V}, U_{W} from the first voltage Uⱼ in accordance with the PWM control signal.

In order to realize the overvoltage protection mentioned at the beginning, known systems consisting of two on-board networks usually use a communication interface which comprises an optocoupler for galvanic isolation of the two on-board networks. However, the aim of the invention is to provide more cost-effective and more compact overvoltage protection.

While FIG. 1 refers to the first on-board network 1 as the high-voltage domain and the second on-board network 2 as the low-voltage domain, this is only to be understood as an exemplary distinction. In particular, it is also possible for the first on-board network 1 to correspond to a low-voltage domain and the second on-board network 2 to correspond to a high-voltage domain. In this case, the bus signal generating device 200 can include a DC/DC converter that is configured to provide the signal voltage required for the communication interface 300. An overvoltage can occur both within the high-voltage domain and within the low-voltage domain and jump to the communication interface 300.

FIG. 2 shows a schematic representation of a control device 100 according to an exemplary embodiment of the invention. The control device 100 is configured to control a load in a vehicle with a first on-board network 1, which is operated with a first voltage U₁ (e.g. 48 V), and a second on-board network 2, which is operated with a second voltage U₂ (e.g. 12 V), wherein the first voltage U₁ is greater than the second voltage U₂, as described above in connection with FIG. 1.

The control device 100 comprises a reference voltage generating unit 1001 which is configured to provide a reference voltage. The reference voltage may be less than or equal to a voltage at which data transmission is carried out between the first on-board network 1 and the second on-board network 2. For example, the reference voltage can be less than or equal to the second voltage U₂. Preferably, the reference voltage provided by the reference voltage generating unit 1001 can be equal to the second voltage U₂. The reference voltage generating unit 1001 can, for example, be provided by a DC/DC converter, which is configured to convert the first voltage U₁ applied to an input of the DC/DC converter into the reference voltage (e.g. U₂).

The control device 100 further comprises a signal voltage limiting unit 1000 configured to receive a bus signal from the second on-board network 1 and to limit a voltage of the bus signal to at most the reference voltage. For example, a logical one of the bus signal with a voltage value (e.g. 48 V) greater than the reference voltage (e.g. 12 V), i.e. with an overvoltage value, is limited to be a logical one with a voltage value equal to the reference voltage (e.g. 12 V). A logical zero (i.e. 0 V) remains unchanged.

The control device 100 further comprises a bus signal receiving unit 1002 configured to receive the voltage-limited bus signal from the signal voltage limiting unit 1002. Thus, a value of a voltage signal received by the bus signal receiving unit 1002 is always less than the reference voltage.

The control device 100 further comprises a supply voltage generating unit 1003 configured to generate, according to the voltage-limited bus signal, a supply voltage for the load 120 based on the first voltage U₁. The supply voltage generated by the supply voltage generating unit may be an AC voltage having two or more phases, each having an amplitude equal to the first voltage U₁ and a frequency according to the voltage-limited bus signal. The generation of the supply voltage can be realized as described in connection with FIG. 1.

The signal voltage limiting unit 1000 may comprise a metal-oxide-semiconductor field-effect transistor, MOSFET, having a source, a gate and a drain, wherein the reference voltage is applied to the gate of the MOSFET. A MOSFET is a transistor that is controlled by a voltage applied to the gate, wherein the MOSFET is controlled to either conduct or block a current flow between the source and drain. The voltage applied to the gate, source or drain is also referred to as the gate, source or drain voltage.

The MOSFET may be configured to inhibit if a drain voltage applied to the drain of the MOSFET is greater than the reference voltage, so that the reference voltage is received by the bus signal receiving unit as the voltage-limited bus signal. The MOSFET can also be configured to conduct if the drain voltage is lower than the reference voltage, so that the drain voltage is received by the bus signal receiving unit as the voltage-limited signal.

The MOSFET can preferably be an n-channel MOSFET of the enhancement type. The gate may be connected to a positive output of the reference voltage generating unit 1001. An enhancement type MOSFET is also referred to as self-blocking, meaning that it blocks when there is no voltage between the gate and the source. A self-blocking n-channel MOSFET conducts when a gate-source voltage U_{GS} between gate and source exceeds a certain positive threshold value U_{TH}. A self-blocking p-channel MOSFET, on the other hand, conducts when the gate-source voltage U_{GS} falls below a certain negative threshold value U_{TH}.

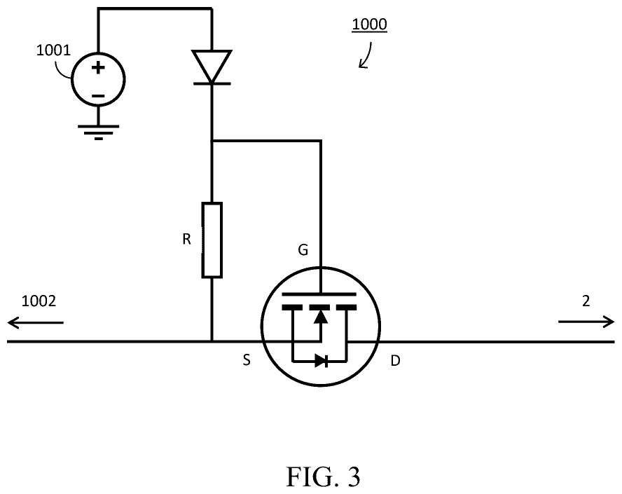

FIG. 3 shows a circuit diagram of a signal voltage limiting unit 1000 according to an exemplary embodiment of the invention. In addition to the MOSFET, the signal voltage limiting unit further comprises a diode and a resistor R (e.g. 1 kΩ), wherein the gate of the MOSFET is connected to the reference voltage generating unit 1001 via the diode and is connected to the bus signal receiving unit 1002 via the resistor. Furthermore, the source of the MOSFET is connected to the bus signal receiving unit 1002 and is connected to the reference voltage generating unit 1001 via the resistor and the diode. The drain of the MOSFET is configured to receive the bus signal from the second on-board network 2. The resistor R can also be referred to as a pull-up resistor.

If the bus signal received from the second on-board network is a logical zero, the drain voltage is 0 V (earth potential) at the time of transmission. The reference voltage (e.g. 12 V) is present at both the gate and the source at this time, i.e. the gate-source voltage U_{GS} is 0 V, so that the MOSFET blocks. Due to its internal structure, a MOSFET contains a so-called parasitic diode (or substrate diode) between the source and drain, which always conducts when the source voltage is greater than the drain voltage. As a result, the source voltage drops across the parasitic diode (i.e. a small current flows from the source to the drain) so that the gate-source voltage U_{GS} rises above the threshold value U_{TH} and the MOSFET begins to conduct, bypassing the parasitic diode. As a result, the source voltage drops to 0 V (ground potential) and the signal voltage limiting unit 102 receives the logical zero of the bus signal.

If the bus signal received from the second on-board network is a logical one with a voltage value (e.g. 48 V) greater than the reference voltage (e.g. 12 V), i.e. with an overvoltage value, the drain voltage is equal to the overvoltage value at the time of transmission. The reference voltage (e.g. 12 V) is present at both the gate and the source at this time, i.e. the gate-source voltage U_{GS} is 0 V, so that the MOSFET blocks. As the source voltage is lower than the drain voltage, the source voltage does not drop across the parasitic diode, so that the gate-source voltage U_{GS} remains below the threshold value U_{TH} and the MOSFET blocks. Thus, the source voltage remains equal to the reference voltage (e.g. 12 V) and the signal voltage limiting unit 102 receives the logical one of the bus signal as a voltage-limited bus signal, where the logical one has a voltage value equal to the reference voltage (e.g. 12 V).

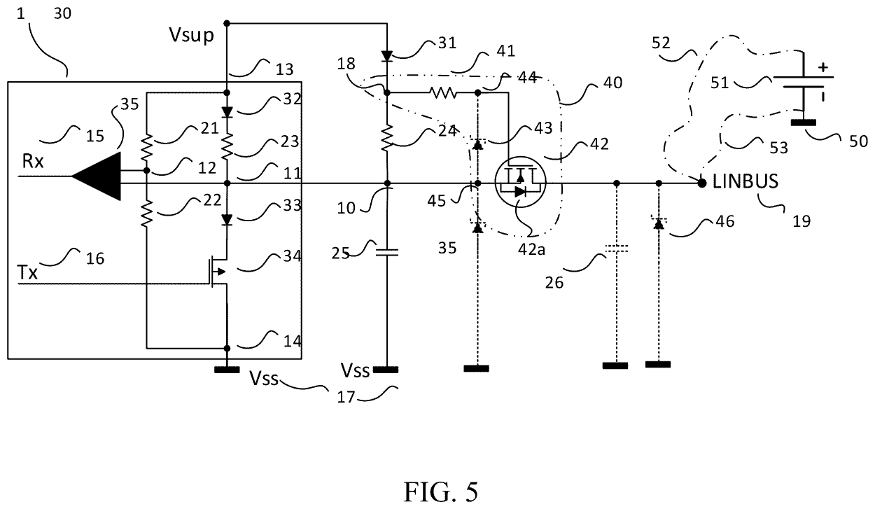

Furthermore, it is possible to extend the signal voltage limiting unit 1000 shown in FIG. 3 by connecting the gate of the MOSFET to the diode and the (pull-up) resistor via a protection resistor and connecting the source of the MOSFET to the gate and the protection resistor via a Zener diode. Such a circuit and its mode of operation are explained in more detail below in connection with FIG. 5. It is thus possible to protect the MOSFET itself from overvoltage by means of the Zener diode.

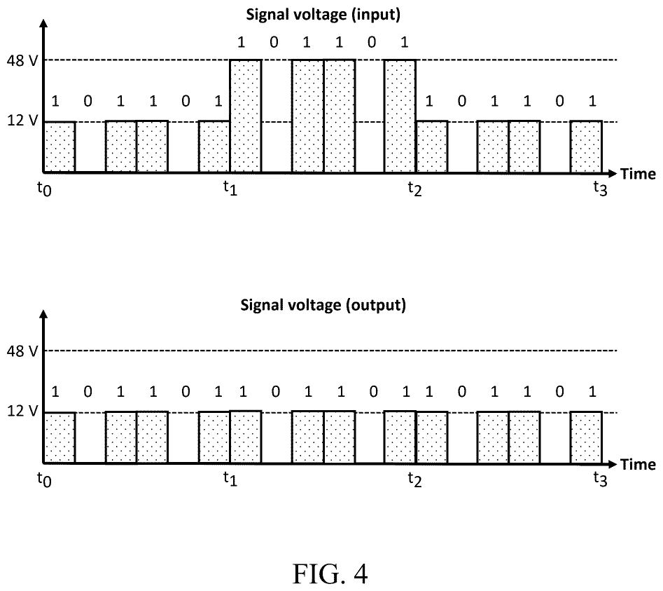

FIG. 4 shows plots of the signal voltage at an input and at an output of the signal voltage limiting unit 1000 according to an exemplary embodiment of the invention. The signal voltage at the input of the signal voltage limiting unit 102 (upper plot) corresponds to the bus signal received from the second on-board network 2. The signal voltage at the output of the signal voltage limiting unit 1000 (lower plot) corresponds to the voltage-limited bus signal output to the bus signal receiving unit 1002.

In the period from t₀ to t₁ as well as in the period from t₂ to t₃, the signal voltage limiting unit 1000 receives the bus signal “101101” with a maximum voltage value equal to the reference voltage (e.g. 12 V), and outputs the received bus signal to the bus signal receiving unit 1002. In the period from t₁ to t₂, however, the signal voltage limiting unit 1000 receives the bus signal “101101” with a maximum voltage value greater than the reference voltage (e.g. 48 V), limits the bus signal “101101” to a maximum voltage value equal to the reference voltage (e.g. 12 V), and outputs the limited bus signal to the bus signal receiving unit 1002, so that the bus signal receiving unit 1002 is protected from an overvoltage.

A control system for a load may comprise one of the above exemplary embodiments for a control device 100, and a bus signal generating device 200 adapted to generate bus signals and transmit the bus signals to the control device 100 as described above in connection with FIG. 1. The bus signal generating device 200 or the control device 100 can be configured to transmit or receive bus signals via a Local Interconnect Network (LIN).

FIG. 5 shows a circuit diagram of an integration of a protection circuit 40 according to an exemplary embodiment of the invention in a LIN-based control system. The LIN-based control system may comprise a LIN-PHY circuit 30, wherein the LIN-PHY circuit 30 is configured to process signals of a physical layer (PHY) according to the LIN industry standard. Suitable examples of the LIN PHY circuit 30 include TJA1021 according to reference [4] and S912ZML according to reference [5].

The LIN-based control system may further comprise the following components: a first external LIN-VBUS terminal 10 for a pull-up resistor 24 and an external dedicated LIN-VBUS bus capacitor 25, wherein the first external LIN-VBUS terminal 10 is connected to the protection circuit 40; a LIN-VBUS receiver/transmitter terminal 11 to an external IC pin of the LIN-PHY circuit 30 (according to the LIN Physical Layer Specification Revision 2.1, param. 37, VBUS); a LIN VBUS receiver reference input 12 from a voltage divider; a LIN voltage source 13 providing a voltage Vₛᵤₚ (according to LIN Physical Layer Specification Revision 2.1, param. 10 and param. 11 for maximum voltage value range (40V)); a first LIN ground 14 with potential V_{SS}; a LIN digital receiver signal output 15; a LIN digital transmitter signal input 16; a second LIN ground 17 for the external dedicated LIN VBUS bus capacitor 25 and connected to the first LIN ground 14; a second external LIN-VBUS terminal 18 for an external LIN-VBUS pull-up diode 31 and the pull-up resistor 24; a LIN-VBUS receiver reference voltage divider top side resistor 21 for the voltage Vₛᵤₚ; a LIN-VBUS receiver reference voltage divider bottom side resistor 22 for the voltage V_{SS}; an internal LIN-VBUS pull-up resistor 23 (according to the LIN Physical Layer Specification Revision 2.1, param. 26, Rslave); the external dedicated LIN-VBUS bus capacitor 25 (according to the LIN Physical Layer Specification Revision 2.1, param. 37, Cslave); the external LIN-VBUS pull-up diode 31 connected to the LIN voltage source 13 and the pull-up resistor 24 (according to the LIN Physical Layer Specification Revision 2.1, param. 21, Dser_Master); an internal LIN_VBUS pull-up diode 32 (according to the LIN Physical Layer Specification Revision 2.1, param. 21, Dser_int); an internal LIN-VBUS transmitter transistor 34, a LIN-VBUS receiver comparator element 35; an optional LINBUS ESD LIN bus protection 36; an optional LINBUS EMC capacitor 26; an external LIN BUS line 19 (according to LIN Physical Layer Specification Revision 2.1, param. 37, VBUS) connected to protection circuit 40.

The protection circuit 40 may further comprise: a (serial) protection transistor 42; a (serial) protection resistor 41 between the external LIN-VBUS pull-up diode 31 and a gate of the serial protection transistor 42; and an optional gate Zener diode 43 between the serial protection resistor 41 and a gate of the serial protection transistor 42. The protection transistor 42 may be a MOSFET or preferably an enhancement type n-channel MOSFET. Regarding the functional principle of the protection transistor 42, reference is made to the explanations above in connection with FIG. 3.

The serial protection resistor 41 can be used to control transitions of the serial protection transistor 42 between a blocking state (high impedance) and a conducting state (low impedance). If the voltage Vₛᵤₚ provided by the LIN voltage source 13 exceeds the gate-source voltage threshold of the serial protection transistor 42, the serial protection resistor 41 may further serve to limit a current flow through the gate Zener diode 43. In this case, overvoltage may exceed a breakdown voltage of the gate Zener diode 43 such that it conducts in the reverse direction (i.e., the current flow limited by the serial protection resistor 41). In other words, in this case, the gate Zener diode 43 connects the points 44 and 45 in the circuit of FIG. 5. It is thus possible to protect the serial protection transistor 42 itself from an overvoltage by means of the gate Zener diode 43. A vehicle may comprise one of the above exemplary embodiments for a control system.

### LIST OF REFERENCE SIGNS

1 first on-board network
2 second on-board network
10 first external LIN-VBUS terminal
11 LIN-VBUS receiver/transmitter terminal
12 LIN-VBUS receiver reference input
13 LIN voltage source
14 first LIN ground
15 LIN digital receiver signal output
16 LIN digital transmitter signal input
17 second LIN ground
18 second external LIN-VBUS terminal
19 external LIN BUS line
21 LIN-VBUS receiver reference voltage divider top side resistor
22 LIN-VBUS receiver reference voltage divider bottom side resistor
23 internal LIN-VBUS pull-up resistor
24 pull-up resistor
25 external dedicated LIN-VBUS bus capacitor
26 LINBUS EMC capacitor
30 LIN-PHY circuit
31 external LIN-VBUS pull-up diode
32 internal LIN_VBUS pull-up diode
34 internal LIN-VBUS transmitter transistor
35 LIN-VBUS receiver comparator element
36 LINBUS ESD LIN bus protection
40 protection circuit
41 (serial) protection resistor
42 (serial) protection transistor
43 gate Zener diode
100 control device
110 first operating voltage source
120 load
200 bus signal generating device
210 second operating voltage source
300 communication interface
1000 signal voltage limiting unit
1001 reference voltage generating unit
1002 bus signal receiving unit
1003 supply voltage generating unit

What is claimed is:

1. A control device for a load in a vehicle with a first on-board network operated using a first voltage and a second on-board network operated using a second voltage, wherein the first voltage is greater than the second voltage, the control device comprising:
a reference voltage generating unit configured to provide a reference voltage;
a signal voltage limiting unit configured to receive a bus signal from the second on-board network and to limit a voltage of the bus signal to at most the reference voltage;
a bus signal receiving unit configured to receive a voltage-limited bus signal from the signal voltage limiting unit; and
a supply voltage generating unit configured to generate, according to the voltage-limited bus signal, a supply voltage for the load based on the first voltage.

2. The control device according to claim 1, wherein the signal voltage limiting unit comprises a metal-oxide semiconductor field-effect transistor, MOSFET, with a source, a gate, and a drain, wherein the reference voltage is applied to the gate of the MOSFET.

3. The control device according to claim 2, wherein the MOSFET is configured to:
block, if a drain voltage applied to the drain of the MOSFET is greater than the reference voltage, such that the reference voltage from the bus signal receiving unit is received as the voltage-limited bus signal; and
conduct, if the drain voltage is less than the reference voltage, such that the drain voltage from the bus signal receiving unit is received as the voltage-limited bus signal.

4. The control device according to claim 2, wherein the MOSFET is a n-channel MOSFET of an enhancement type.

5. The control device according to claim 2, wherein the signal voltage limiting unit further comprises:
a diode; and
a resistor, wherein the gate of the MOSFET is connected to the reference voltage generating unit via the diode and to the bus signal receiving unit via the resistor, wherein the source of the MOSFET is connected to the bus signal receiving unit and to the reference voltage generating unit via the resistor and the diode, and wherein the drain of the MOSFET is configured to receive the bus signal from the second on-board network.

6. The control device according to claim 1, wherein the reference voltage provided by the reference voltage generating unit is equal to the second voltage.

7. The control device according to claim 1, wherein the supply voltage generated by the supply voltage generating unit is an alternating voltage with two or more phases each with an amplitude corresponding to the first voltage and a frequency corresponding to the voltage-limited bus signal.

8. A control system for the load comprising:
the control device according to claim 1; and
a bus signal generating device configured to generate bus signals and to transmit the bus signals to the control device.

9. The control system according to claim 8, wherein the bus signal generating device and the control device are respectively configured to transmit and receive bus signals via a local interconnect network, LIN.

10. A vehicle comprising the control system according to claim 8.
